(19) United States
(12) Patent Application Publication
(10) Pub. No.: US 2020/0202370 A1
(43) Pub. Date: Jun. 25, 2020

(54) METHODS AND APPARATUS TO ESTIMATE MISATTRIBUTION OF MEDIA IMPRESSIONS

(71) Applicant: The Nielsen Company (US), LLC, New York, NY (US)

(72) Inventors: Michael Sheppard, Holland, MI (US); Ludo Daemen, Duffel (BE); Jonathan Sullivan, Hurricane, UT (US)

(21) Appl. No.: 16/230,810

(22) Filed: Dec. 21, 2018

(51) Int. Cl. G06Q 30/02; G06N 7/00; G06F 17/16

(52) U.S. Cl. CPC G06Q 30/0204; G06F 17/16; G06N 7/005

(57) ABSTRACT

An example apparatus includes a misattribution matrix generator to generate a misattribution matrix based on panelist data corresponding to audience measurement panelists. The misattribution matrix representing a panelist media impression as misattributed to a first demographic group by a database proprietor when the panelist media impression corresponds to a second demographic group. The apparatus also includes a census distribution analyzer to determine, based on the misattribution matrix, probability values that different census distribution models correspond to a true census distribution for census media impressions indicated in a misattributed census distribution. The true census distribution indicating a distribution of the census media impressions across the first and second demographic groups and accounting for misattribution by the database proprietor in the misattributed census distribution. The census distribution analyzer also to estimate the true census distribution based on the probability values.

### FIELD OF THE DISCLOSURE

This disclosure relates generally to audience measurement and, more particularly, to methods and apparatus to estimate misattribution of media impressions.

### BACKGROUND

Traditionally, audience measurement entities determine audience exposure to media based on registered panel members. That is, an audience measurement entity (AME) enrolls people who consent to being monitored into a panel. The AME then monitors those panel members to determine media (e.g., television programs or radio programs, movies, DVDs, advertisements, webpages, streaming media, etc.) exposed to those panel members. In this manner, the audience measurement entity can determine exposure metrics for different media based on the collected media measurement data.

### BRIEF DESCRIPTION OF THE DRAWINGS

FIG. 1A illustrates an example communication flow diagram of an example manner in which an audience measurement entity (AME) can collect impressions and/or demographic information associated with audience members exposed to media.

FIG. 1B depicts an example system to collect impressions of media presented on mobile devices and to collect impression information from distributed database proprietors for associating with the collected impressions.

FIG. 2 is a block diagram illustrating an example implementation of the audience measurement analyzer of FIGS. 1A and/or 1B.

FIG. 3 is a flowchart representative of machine readable instructions that may be executed to implement the example audience measurement analyzer of FIGS. 1A, 1B, and/or 2.

FIG. 4 is example pseudocode representative of machine readable instructions that may be executed to implement the example audience measurement analyzer of FIGS. 1A, 1B, and/or 2.

FIG. 5 is a block diagram of an example processing platform structured to execute the instructions of FIGS. 3 and/or 4 to implement the example audience measurement analyzer of FIGS. 1A, 1B, and/or 2.

In general, the same reference numbers will be used throughout the drawing(s) and accompanying written description to refer to the same or like parts.

### DETAILED DESCRIPTION

As used herein, a media impression (or simply an impression) refers to when a person is exposed to a particular item of media. Each time a person is exposed to the media item constitutes a separate media impression. Thus, the same person will have multiple impressions for the same media item when the person is exposed to the same media item multiple times. The number of impressions of media experienced by a single person, as well as the total number of impressions experienced by all people within a relevant population are audience measurements that AMEs seek to track. One way in which AMEs are able to track impressions is by enlisting individuals to serve as panelists on an audience measurement panel. AMEs monitor or track the panelists' usage of media devices and/or exposure to media presented on those media devices to determine what media the panelists are exposed to and then credit the corresponding panelists and with media impressions. For example, an AME server logs records of impressions that credit audience members as having been exposed to media and similarly credit the media with exposures to those audience members. By selecting panelists with demographic characteristics that are representative of a general population, AMEs are able to reliably extrapolate the impressions credited to the panelists to total impressions for a corresponding general population. More particularly, based on known demographic characteristics of the panelists, AMEs may estimate the distribution of impressions across different demographic characteristics within the general population.

In more recent years, techniques have been developed to enable AMEs to track the number of impressions of Internet-based media (e.g., web pages, online advertisements, streaming videos, and/or other media) without the need for enlisting panelists. For example, the inventions disclosed in Blumenau, U.S. Pat. No. 6,102,637, which is hereby incorporated herein by reference in its entirety, involve a technique wherein Internet media to be tracked is tagged with beacon instructions. In particular, monitoring instructions are associated with the Hypertext Markup Language (HTML) of the media to be tracked. When a client requests the media, both the media and the beacon instructions are downloaded to the client. The beacon instructions are, thus, executed whenever the media is accessed, be it from a server or from a cache.

The beacon instructions cause monitoring data reflecting information about the access to the media (e.g., the occurrence of a media impression) to be sent from the client that downloaded the media to a monitoring entity. Typically, the monitoring entity is an AME (e.g., any entity interested in measuring or tracking audience exposures to advertisements, media, and/or any other media) that did not provide the media to the client and who is a trusted third party for providing accurate usage statistics (e.g., The Nielsen Company, LLC). Advantageously, because the beaconing instructions are associated with the media and executed by the client browser whenever the media is accessed, the monitoring information is provided to the AME irrespective of whether the client is associated with a panelist of the AME. In this manner, the AME is able to track every time a person is exposed to the media on a census-wide or population-wide level. As a result, the AME can reliably determine the total impression count for the media without having to extrapolate from panel data collected from a relatively limited pool of panelists within the population. As used herein, the term “census” (e.g., as in census data, census impressions, census distributions, etc.) refers to an entire population of interest to the AME rather than merely to the select individuals enrolled as panelists. Thus, by way of comparison, panelist media impressions (or simply panelist impressions) refer to impressions by panelists of an audience measurement panel, whereas census media impressions (or simply census impressions) refer to impressions by any audience member regardless of whether they are panelists. As such, census impressions often include panelist impressions in addition to impressions from non-panelists.

Tracking impressions by tagging media with beacon instructions in this manner is insufficient, by itself, to enable an AME to reliably determine the distribution of impressions across different demographics and/or to determine the frequency with which individual audience members were exposed to the media (e.g., the number of impressions had by each unique person). These metrics cannot be determined because the collected monitoring information does not uniquely identify the person(s) exposed to the media and/or the demographic characteristics of such person(s). That is, the AME cannot determine whether two reported impressions are associated with the same person, two separate people that share common demographic characteristics, or two separate people that are demographically distinct. The AME may set a cookie on the client devices reporting the monitoring information to identify when multiple impressions occur using the same device. However, cookie information does not indicate whether the same person used the client device in connection with each media impression. Furthermore, the same person may access media using multiple different devices that have different cookies so that the AME cannot directly determine when two separate impressions are associated with the same person or two different people.

Furthermore, the monitoring information reported by a client device executing the beacon instructions does not provide an indication of the demographics or other user information associated with the person(s) exposed to the associated media. To at least partially address this issue, the AME may establish a panel of users who have agreed to provide their demographic information and to have their Internet browsing activities monitored. When an individual joins the panel, they provide detailed information concerning their identity and demographics (e.g., gender, race, income, home location, occupation, etc.) to the AME. The AME sets a cookie on the panelist computer that enables the AME to identify the panelist whenever the panelist accesses tagged media and, thus, sends monitoring information to the AME. Since most of the client devices providing monitoring information from the tagged pages are not panelists and, thus, are unknown to the AME, it is necessary to use statistical methods to impute demographic information based on the data collected for panelists to the larger population of users providing data for the tagged media. However, panel sizes of AMEs remain small compared to the general population of users. Thus, a problem is presented as to how to increase panel sizes while ensuring the demographics data of the panel is accurate.

There are many database proprietors operating on the Internet. These database proprietors provide services (e.g., social networking services, email services, media access services, etc.) to large numbers of subscribers. In exchange for the provision of such services, the subscribers register with the proprietors. As part of this registration, the subscribers provide detailed demographic information. Examples of such database proprietors include social network providers such as Facebook, Myspace, Twitter, etc. These database proprietors set cookies on the computers of their subscribers to enable the database proprietors to recognize registered users when such registered users visit their websites.

Unlike traditional media measurement techniques in which AMEs rely solely on their own panel member data to collect demographics-based audience measurement, example methods, apparatus, and/or articles of manufacture disclosed herein enable an AME to share demographic information with other entities that operate based on user registration models. As used herein, a user registration model is a model in which users subscribe to services of those entities by creating an account and providing demographic-related information about themselves. Sharing of demographic information associated with registered users of database proprietors enables an AME to extend or supplement their panel data with substantially reliable demographics information from external sources (e.g., database proprietors), thus extending the coverage, accuracy, and/or completeness of their demographics-based audience measurements. Such access also enables the AME to monitor persons who would not otherwise have joined an AME panel. Any web service provider entity having a database identifying demographics of a set of individuals may cooperate with the AME. Such entities may be referred to as “database proprietors” and include entities such as wireless service carriers, mobile software/service providers, social medium sites (e.g., Facebook, Twitter, MySpace, etc.), online retailer sites (e.g., Amazon.com, Buy.com, etc.), multi-service sites (e.g., Yahoo!, Google, Experian, etc.), and/or any other Internet sites that collect demographic data of users and/or otherwise maintain user registration records.

The use of demographic information from disparate data sources (e.g., high-quality demographic information from the panels of an audience measurement entity and/or registered user data of web service providers) results in improved reporting effectiveness of metrics for both online and offline advertising campaigns. Example techniques disclosed herein use online registration data to identify demographics of users, and/or other user information, and use server impression counts, and/or other techniques to track quantities of impressions attributable to those users.

Just as database proprietors may share demographic information that matches collected cookie information of unique individuals to enable an AME to assess the demographic composition of an audience, examples disclosed herein take advantage of information from database proprietors to estimate the distribution of media impressions across different demographics for a census-wide audience population.

Typically, audience measurement information provided by database proprietors is limited to summary or aggregated statistics of the total number of unique audience members and the total number of impressions experienced by the audience members. In some examples, the audience measurement information provided by database providers is further divided into different buckets associated with different demographic characteristics. For example, database proprietors may provide separate numbers for female audience members and male audience members, separate numbers for audience members in different age brackets, separate numbers for audience members located in different geographic regions, and/or separate numbers for audience members distinguished based on any other demographic characteristic(s).

While audience measurement information shared by database proprietors divided across one or more demographic characteristics provides an initial indication of the distribution of impressions across the relevant demographic characteristics, the distribution is not reliable by itself because it is likely a portion of the impressions were credited to the wrong person such that the aggregated statistics associate the corresponding impressions with the wrong demographic. For example, a particular device may include a cookie that is recognized by a database proprietor as being associated with a 47-year-old male who owns the device. However, there may be times when a 14-year-old female (e.g., the daughter of the 47-year-old male) uses the device to access media. At these times, the database proprietor would incorrectly credit the impressions associated with accessing the media to the 47-year-old male when they should be credited to the 14-year-old female.

Crediting the wrong person with an impression is sometimes referred to as misattribution of the impression. Stated generally, misattribution occurs when a media impression is attributed to a first person (or a corresponding first demographic group) when the media impression actually corresponds to a second person (or a corresponding second demographic group). Misattribution is much less of a concern for audience measurement data collected by an AME from panelists because the AME is typically able to confirm the identity of individuals accessing media via devices being monitored (e.g., through visual and/or audio detection of the individuals and/or by having the individuals (e.g., panelists) self-identify).

Thus, AMEs are able to generate accurate distributions of impressions across demographics that account for potential misattribution situations where one person is accessing media via a device that would be credited to another person based on cookie information collected from the device. However, as noted above, this distribution is limited to a relatively small pool of panelists (e.g., numbering in the hundreds or thousands). By contrast, database proprietors have demographic information from relatively large pools (e.g., numbering in the tens of millions or more). However, impression distributions based on audience measurement information collected by database proprietors cannot account for misattribution of impressions. Examples disclosed herein use the accurate (e.g., properly attributed) impressions distributions based on panelist data collected by AMEs and the inaccurate (e.g., misattributed) impressions distributions provided by database proprietors to estimate an accurate impressions distribution associated with the population-wide or census-wide demographics information available to the database proprietor.

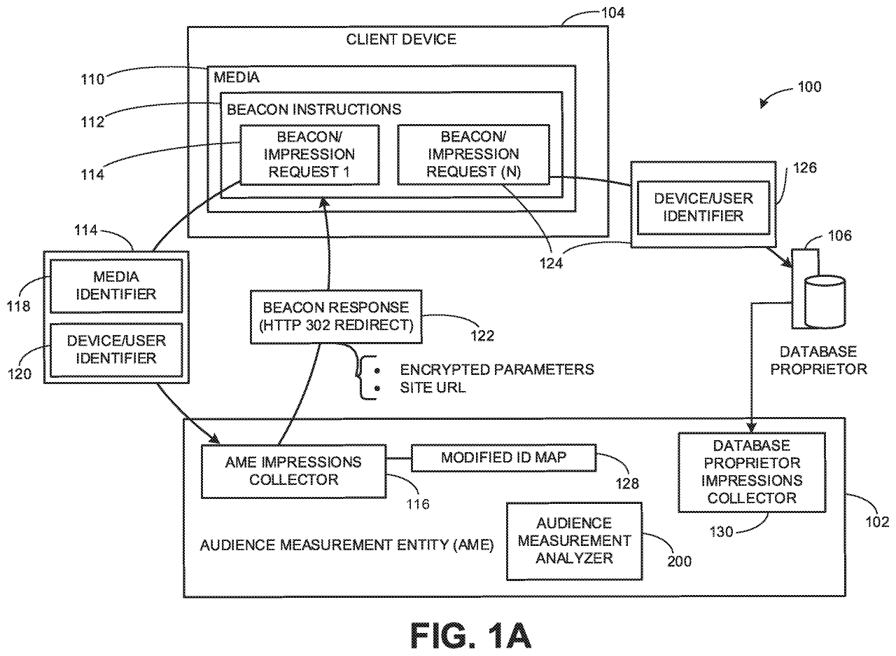

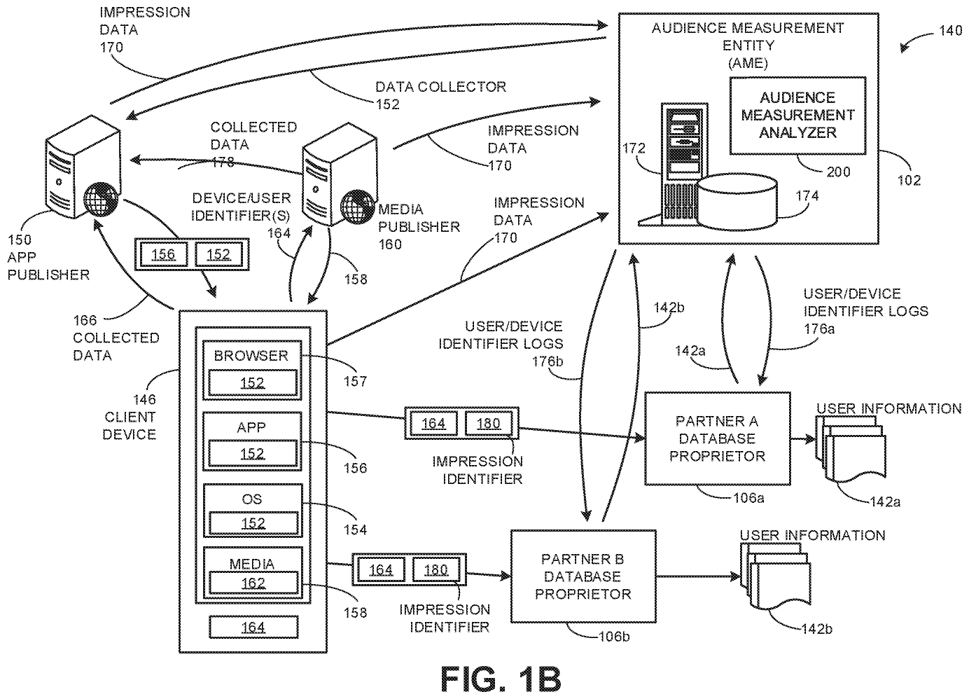

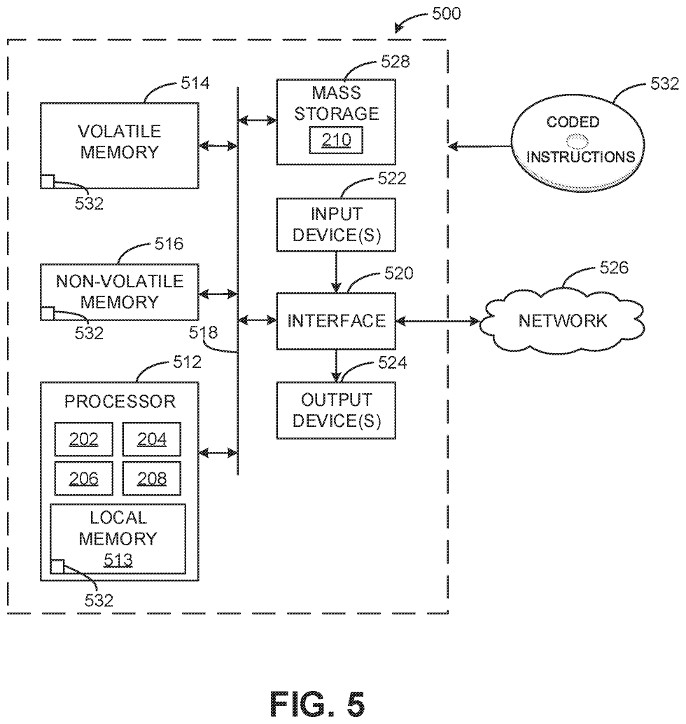

FIG. 1A is an example communication flow diagram 100 of an example manner in which an audience measurement entity (AME) 102 can collect audience measurement data representative of impressions of media accessed on, and reported by, client devices 104. In some examples, the AME 102 includes an example audience measurement analyzer 200 to be implemented by a computer/processor system (e.g., the processor system 500 of FIG. 5) that may analyze the collected audience measurement data to determine the distribution of impressions of audience members across different demographics that account for misattribution. In some examples, the AME 102 communicates with a database proprietor 106 to collect demographic information associated with audience members exposed to media. In some examples, the database proprietor 106 may provide summary or aggregate statistics indicative of the distribution of impressions of audience members across different demographics. However, the distribution information provided by the database proprietor does not account for misattribution such that there is some likelihood that the impressions reported as being associated with a particular demographic should be associated with other demographics in the distribution.

Demographic impressions refer to impressions that can be associated with particular individuals for whom specific demographic information is known. The example chain of events shown in FIG. 1A occurs when a client device 104 accesses media 110 for which the client device 104 reports an impression to the AME 102 and/or the database proprietor 106. In some examples, the client device 104 reports impressions for accessed media based on instructions (e.g., beacon instructions) embedded in the media that instruct the client device 104 (e.g., instruct a web browser or an app in the client device 104) to send beacon/impression requests to the AME 102 and/or the database proprietor 106. In such examples, the media having the beacon instructions is referred to as tagged media. In other examples, the client device 104 reports impressions for accessed media based on instructions embedded in apps or web browsers that execute on the client device 104 to send beacon/impression requests to the AME 102 and/or the database proprietor 106 for corresponding media accessed via those apps or web browsers. In any case, the beacon/impression requests include device/user identifiers (IDs) (e.g., AME IDs and/or database proprietor IDs) to allow the corresponding AME 102 and/or the corresponding database proprietor 106 to associate demographic information with resulting logged impressions.

In the illustrated example, the client device 104 accesses media 110 that is tagged with the beacon instructions 112. The beacon instructions 112 cause the client device 104 to send a beacon/impression request 114 to an AME impressions collector 116 when the client device 104 accesses the media 110. For example, a web browser and/or app of the client device 104 executes the beacon instructions 112 in the media 110 which instruct the browser and/or app to generate and send the beacon/impression request 114. In the illustrated example, the client device 104 sends the beacon/impression request 114 using a network communication including an HTTP (hypertext transfer protocol) request addressed to the URL (uniform resource locator) of the AME impressions collector 116 at, for example, a first internet domain of the AME 102. The beacon/impression request 114 of the illustrated example includes a media identifier 118 (e.g., an identifier that can be used to identify content, an advertisement, and/or any other media) corresponding to the media 110. In some examples, the beacon/impression request 114 also includes a site identifier (e.g., a URL) of the website that served the media 110 to the client device 104 and/or a host website ID (e.g., www.acme.com) of the website that displays or presents the media 110. In the illustrated example, the beacon/impression request 114 includes a device/user identifier 120. In the illustrated example, the device/user identifier 120 that the client device 104 provides to the AME impressions collector 116 in the beacon impression request 114 is an AME ID because it corresponds to an identifier that the AME 102 uses to identify a panelist corresponding to the client device 104. In other examples, the client device 104 may not send the device/user identifier 120 until the client device 104 receives a request for the same from a server of the AME 102 in response to, for example, the AME impressions collector 116 receiving the beacon/impression request 114.

In some examples, the device/user identifier 120 may include a hardware identifier (e.g., an international mobile equipment identity (IMEI), a mobile equipment identifier (MEID), a media access control (MAC) address, etc.), an app store identifier (e.g., a Google Android ID, an Apple ID, an Amazon ID, etc.), a unique device identifier (UDID) (e.g., a non-proprietary UDID or a proprietary UDID such as used on the Microsoft Windows platform), an open source unique device identifier (OpenUDID), an open device identification number (ODIN), a login identifier (e.g., a username), an email address, user agent data (e.g., application type, operating system, software vendor, software revision, etc.), an Ad-ID (e.g., an advertising ID introduced by Apple, Inc. for uniquely identifying mobile devices for the purposes of serving advertising to such mobile devices), an Identifier for Advertisers (IDFA) (e.g., a unique ID for Apple iOS devices that mobile ad networks can use to serve advertisements), a Google Advertising ID, a Roku ID (e.g., an identifier for a Roku OTT device), a third-party service identifier (e.g., advertising service identifiers, device usage analytics service identifiers, demographics collection service identifiers), web storage data, document object model (DOM) storage data, local shared objects (also referred to as “Flash cookies”), and/or any other identifier that the AME 102 stores in association with demographic information about users of the client devices 104. In this manner, when the AME 102 receives the device/user identifier 120, the AME 102 can obtain demographic information corresponding to a user of the client device 104 based on the device/user identifier 120 that the AME 102 receives from the client device 104. In some examples, the device/user identifier 120 may be encrypted (e.g., hashed) at the client device 104 so that only an intended final recipient of the device/user identifier 120 can decrypt the hashed identifier 120. For example, if the device/user identifier 120 is a cookie that is set in the client device 104 by the AME 102, the device/user identifier 120 can be hashed so that only the AME 102 can decrypt the device/user identifier 120. If the device/user identifier 120 is an IMEI number, the client device 104 can hash the device/user identifier 120 so that only a wireless carrier (e.g., the database proprietor 106) can decrypt the hashed identifier 120 to recover the IMEI for use in accessing demographic information corresponding to the user of the client device 104. By hashing the device/user identifier 120, an intermediate party (e.g., an intermediate server or entity on the Internet) receiving the beacon request cannot directly identify a user of the client device 104.

In response to receiving the beacon/impression request 114, the AME impressions collector 116 logs an impression for the media 110 by storing the media identifier 118 contained in the beacon/impression request 114. In the illustrated example of FIG. 1A, the AME impressions collector 116 also uses the device/user identifier 120 in the beacon/impression request 114 to identify AME panelist demographic information corresponding to a panelist of the client device 104. That is, the device/user identifier 120 matches a user ID of a panelist member (e.g., a panelist corresponding to a panelist profile maintained and/or stored by the AME 102). In this manner, the AME impressions collector 116 can log a demographic impression by associating the logged impression with demographic information of a panelist corresponding to the client device 104.

In some examples, the beacon/impression request 114 may not include the device/user identifier 120 if, for example, the user of the client device 104 is not an AME panelist. In such examples, the AME impressions collector 116 logs impressions regardless of whether the client device 104 provides the device/user identifier 120 in the beacon/impression request 114 (or in response to a request for the identifier 120). When the client device 104 does not provide the device/user identifier 120, the AME impressions collector 116 will still benefit from logging an impression for the media 110 even though it will not have corresponding demographics (e.g., an impression may be collected as a census impression). For example, the AME 102 may still use the logged impression to generate a total impressions count and/or a frequency of impressions (e.g., an impressions frequency) for the media 110. Additionally or alternatively, the AME 102 may obtain demographics information from the database proprietor 106 for the logged impression if the client device 104 corresponds to a subscriber of the database proprietor 106.

In the illustrated example of FIG. 1A, to compare or supplement panelist demographics (e.g., for accuracy or completeness) of the AME 102 with demographics from one or more database proprietors (e.g., the database proprietor 106), the AME impressions collector 116 returns a beacon response message 122 (e.g., a first beacon response) to the client device 104 including an HTTP “302 Found” re-direct message and a URL of a participating database proprietor 106 at, for example, a second internet domain. In the illustrated example, the HTTP “302 Found” re-direct message in the beacon response 122 instructs the client device 104 to send a second beacon request 124 to the database proprietor 106. In other examples, instead of using an HTTP “302 Found” re-direct message, redirects may be implemented using, for example, an iframe source instruction (e.g., <iframe src=“ ”>) or any other instruction that can instruct a client device to send a subsequent beacon request (e.g., the second beacon request 124) to a participating database proprietor 106. In the illustrated example, the AME impressions collector 116 determines the database proprietor 106 specified in the beacon response 122 using a rule and/or any other suitable type of selection criteria or process. In some examples, the AME impressions collector 116 determines a particular database proprietor to which to redirect a beacon request based on, for example, empirical data indicative of which database proprietor is most likely to have demographic data for a user corresponding to the device/user identifier 120. In some examples, the beacon instructions 112 include a predefined URL of one or more database proprietors to which the client device 104 should send follow up beacon requests 124. In other examples, the same database proprietor is always identified in the first redirect message (e.g., the beacon response 122).

In the illustrated example of FIG. 1A, the beacon/impression request 124 may include a device/user identifier 126 that is a database proprietor ID because it is used by the database proprietor 106 to identify a subscriber of the client device 104 when logging an impression. In some instances (e.g., in which the database proprietor 106 has not yet set a database proprietor ID in the client device 104), the beacon/impression request 124 does not include the device/user identifier 126. In some examples, the database proprietor ID is not sent until the database proprietor 106 requests the same (e.g., in response to the beacon/impression request 124). In some examples, the device/user identifier 126 is a device identifier (e.g., an international mobile equipment identity (IMEI), a mobile equipment identifier (MEID), a media access control (MAC) address, etc.), a web browser unique identifier (e.g., a cookie), a user identifier (e.g., a user name, a login ID, etc.), an Adobe Flash® client identifier, identification information stored in an HTML5 datastore, and/or any other identifier that the database proprietor 106 stores in association with demographic information about subscribers corresponding to the client devices 104. When the database proprietor 106 receives the device/user identifier 126, the database proprietor 106 can obtain demographic information corresponding to a user of the client device 104 based on the device/user identifier 126 that the database proprietor 106 receives from the client device 104. In some examples, the device/user identifier 126 may be encrypted (e.g., hashed) at the client device 104 so that only an intended final recipient of the device/user identifier 126 can decrypt the hashed identifier 126. For example, if the device/user identifier 126 is a cookie that is set in the client device 104 by the database proprietor 106, the device/user identifier 126 can be hashed so that only the database proprietor 106 can decrypt the device/user identifier 126. If the device/user identifier 126 is an IMEI number, the client device 104 can hash the device/user identifier 126 so that only a wireless carrier (e.g., the database proprietor 106) can decrypt the hashed identifier 126 to recover the IMEI for use in accessing demographic information corresponding to the user of the client device 104. By hashing the device/user identifier 126, an intermediate party (e.g., an intermediate server or entity on the Internet) receiving the beacon request cannot directly identify a user of the client device 104. For example, if the intended final recipient of the device/user identifier 126 is the database proprietor 106, the AME 102 cannot recover identifier information when the device/user identifier 126 is hashed by the client device 104 for decrypting only by the intended database proprietor 106.

Although only a single database proprietor 106 is shown in FIG. 1A, the impression reporting/collection process of FIG. 1A may be implemented using multiple database proprietors. In some such examples, the beacon instructions 112 cause the client device 104 to send beacon/impression requests 124 to numerous database proprietors. For example, the beacon instructions 112 may cause the client device 104 to send the beacon/impression requests 124 to the numerous database proprietors in parallel or in daisy chain fashion. In some such examples, the beacon instructions 112 cause the client device 104 to stop sending beacon/impression requests 124 to database proprietors once a database proprietor has recognized the client device 104. In other examples, the beacon instructions 112 cause the client device 104 to send beacon/impression requests 124 to multiple database proprietors so that the multiple database proprietors can recognize the client device 104 and log a corresponding impression. In any case, multiple database proprietors are provided the opportunity to log impressions and provide corresponding demographics information if the user of the client device 104 is a subscriber of services of those database proprietors.

In some examples, prior to sending the beacon response 122 to the client device 104, the AME impressions collector 116 replaces site IDs (e.g., URLs) of media provider(s) that served the media 110 with modified site IDs (e.g., substitute site IDs) which are discernable only by the AME 102 to identify the media provider(s). In some examples, the AME impressions collector 116 may also replace a host website ID (e.g., www.acme.com) with a modified host site ID (e.g., a substitute host site ID) which is discernable only by the AME 102 as corresponding to the host website via which the media 110 is presented. In some examples, the AME impressions collector 116 also replaces the media identifier 118 with a modified media identifier 118 corresponding to the media 110. In this way, the media provider of the media 110, the host website that presents the media 110, and/or the media identifier 118 are obscured from the database proprietor 106, but the database proprietor 106 can still log impressions based on the modified values which can later be deciphered by the AME 102 after the AME 102 receives logged impressions from the database proprietor 106. In some examples, the AME impressions collector 116 does not send site IDs, host site IDs, the media identifier 118 or modified versions thereof in the beacon response 122. In such examples, the client device 104 provides the original, non-modified versions of the media identifier 118, site IDs, host IDs, etc. to the database proprietor 106.

In the illustrated example, the AME impression collector 116 maintains a modified ID mapping table 128 that maps original site IDs with modified (or substitute) site IDs, original host site IDs with modified host site IDs, and/or maps modified media identifiers to the media identifiers such as the media identifier 118 to obfuscate or hide such information from database proprietors such as the database proprietor 106. Also in the illustrated example, the AME impressions collector 116 encrypts all of the information received in the beacon/impression request 114 and the modified information to prevent any intercepting parties from decoding the information. The AME impressions collector 116 of the illustrated example sends the encrypted information in the beacon response 122 to the client device 104 so that the client device 104 can send the encrypted information to the database proprietor 106 in the beacon/impression request 124. In the illustrated example, the AME impressions collector 116 uses an encryption that can be decrypted by the database proprietor 106 site specified in the HTTP “302 Found” re-direct message.

Periodically or aperiodically, the audience measurement data collected by the database proprietor 106 is provided to a database proprietor impressions collector 130 of the AME 102 as, for example, batch data. In some examples, the audience measurement data may be combined or aggregated to generate a demographic-based media impression distribution for individuals exposed to the media 110 that the database proprietor 106 was able to identify (e.g., based on the device/user identifier 126). During a data collecting and merging process to combine demographic and audience measurement data from the AME 102 and the database proprietor(s) 106, impressions logged by the AME 102 for the client devices 104 that do not have a database proprietor ID will not correspond to impressions logged by the database proprietor 106 because the database proprietor 106 typically does not log impressions for the client devices that do not have database proprietor IDs.

Additional examples that may be used to implement the beacon instruction processes of FIG. 1A are disclosed in Mainak et al., U.S. Pat. No. 8,370,489, which is hereby incorporated herein by reference in its entirety. In addition, other examples that may be used to implement such beacon instructions are disclosed in Blumenau, U.S. Pat. No. 6,108,637, referred to above.

FIG. 1B depicts an example system 140 to collect impression information based on user information 142a, 142b from distributed database proprietors 106 (designated as 106a and 106b in FIG. 1B) for associating with impressions of media presented at a client device 146. In the illustrated examples, user information 142a, 142b or user data includes one or more of demographic data, purchase data, and/or other data indicative of user activities, behaviors, and/or preferences related to information accessed via the Internet, purchases, media accessed on electronic devices, physical locations (e.g., retail or commercial establishments, restaurants, venues, etc.) visited by users, etc. Thus, the user information 142a, 142b may indicate and/or be analyzed to determine the impression frequency of individual users with respect to different media accessed by the users. In some examples, such impression information, may be combined or aggregated to generate a media impression frequency distribution for all users exposed to particular media for whom the database proprietor has particular user information 142a, 142b. More particularly, in the illustrated example of FIG. 1B, the AME 102 includes the example audience measurement analyzer 200 to analyze the collected audience measurement data to determine distributions for media impressions across different demographic characteristics that are corrected for misattribution as described more fully below.

In the illustrated example of FIG. 1B, the client device 146 may be a mobile device (e.g., a smart phone, a tablet, etc.), an internet appliance, a smart television, an internet terminal, a computer, or any other device capable of presenting media received via network communications. In some examples, to track media impressions on the client device 146, an audience measurement entity (AME) 102 partners with or cooperates with an app publisher 150 to download and install a data collector 152 on the client device 146. The app publisher 150 of the illustrated example may be a software app developer that develops and distributes apps to mobile devices and/or a distributor that receives apps from software app developers and distributes the apps to mobile devices. The data collector 152 may be included in other software loaded onto the client device 146, such as the operating system 154, an application (or app) 156, a web browser 117, and/or any other software.

Any of the example software 154, 156, 117 may present media 158 received from a media publisher 160. The media 158 may be an advertisement, video, audio, text, a graphic, a web page, news, educational media, entertainment media, or any other type of media. In the illustrated example, a media ID 162 is provided in the media 158 to enable identifying the media 158 so that the AME 102 can credit the media 158 with media impressions when the media 158 is presented on the client device 146 or any other device that is monitored by the AME 102.

The data collector 152 of the illustrated example includes instructions (e.g., Java, java script, or any other computer language or script) that, when executed by the client device 146, cause the client device 146 to collect the media ID 162 of the media 158 presented by the app program 156, the browser 117, and/or the client device 146, and to collect one or more device/user identifier(s) 164 stored in the client device 146. The device/user identifier(s) 164 of the illustrated example include identifiers that can be used by corresponding ones of the partner database proprietors 106a-b to identify the user or users of the client device 146, and to locate user information 142a-b corresponding to the user(s). For example, the device/user identifier(s) 164 may include hardware identifiers (e.g., an international mobile equipment identity (IMEI), a mobile equipment identifier (MEID), a media access control (MAC) address, etc.), an app store identifier (e.g., a Google Android ID, an Apple ID, an Amazon ID, etc.), a unique device identifier (UDID) (e.g., a non-proprietary UDID or a proprietary UDID such as used on the Microsoft Windows platform), an open source unique device identifier (OpenUDID), an open device identification number (ODIN), a login identifier (e.g., a username), an email address, user agent data (e.g., application type, operating system, software vendor, software revision, etc.), an Ad-ID (e.g., an advertising ID introduced by Apple, Inc. for uniquely identifying mobile devices for the purposes of serving advertising to such mobile devices), an Identifier for Advertisers (IDFA) (e.g., a unique ID for Apple iOS devices that mobile ad networks can use to serve advertisements), a Google Advertising ID, a Roku ID (e.g., an identifier for a Roku OTT device), third-party service identifiers (e.g., advertising service identifiers, device usage analytics service identifiers, demographics collection service identifiers), web storage data, document object model (DOM) storage data, local shared objects (also referred to as “Flash cookies”), etc. In examples in which the media 158 is accessed using an application and/or browser (e.g., the app 156 and/or the browser 117) that do not employ cookies, the device/user identifier(s) 164 are non-cookie identifiers such as the example identifiers noted above. In examples in which the media 158 is accessed using an application or browser that does employ cookies, the device/user identifier(s) 164 may additionally or alternatively include cookies. In some examples, fewer or more device/user identifier(s) 164 may be used. In addition, although only two partner database proprietors 106a-b are shown in FIG. 1, the AME 102 may partner with any number of partner database proprietors to collect distributed user information (e.g., the user information 142a-b).

In some examples, the client device 146 may not allow access to identification information stored in the client device 146. For such instances, the disclosed examples enable the AME 102 to store an AME-provided identifier (e.g., an identifier managed and tracked by the AME 102) in the client device 146 to track media impressions on the client device 146. For example, the AME 102 may provide instructions in the data collector 152 to set an AME-provided identifier in memory space accessible by and/or allocated to the app program 156 and/or the browser 117, and the data collector 152 uses the identifier as a device/user identifier 164. In such examples, the AME-provided identifier set by the data collector 152 persists in the memory space even when the app program 156 and the data collector 152 and/or the browser 117 and the data collector 152 are not running. In this manner, the same AME-provided identifier can remain associated with the client device 146 for extended durations. In some examples in which the data collector 152 sets an identifier in the client device 146, the AME 102 may recruit a user of the client device 146 as a panelist, and may store user information collected from the user during a panelist registration process and/or collected by monitoring user activities/behavior via the client device 146 and/or any other device used by the user and monitored by the AME 102. In this manner, the AME 102 can associate user information of the user (from panelist data stored by the AME 102) with media impressions attributed to the user on the client device 146. As used herein, a panelist is a user registered on a panel maintained by a ratings entity (e.g., the AME 102) that monitors and estimates audience exposure to media.

In the illustrated example, the data collector 152 sends the media ID 162 and the one or more device/user identifier(s) 164 as collected data 166 to the app publisher 150. Alternatively, the data collector 152 may be configured to send the collected data 166 to another collection entity (other than the app publisher 150) that has been contracted by the AME 102 or is partnered with the AME 102 to collect media IDs (e.g., the media ID 162) and device/user identifiers (e.g., the device/user identifier(s) 164) from user devices (e.g., the client device 146). In the illustrated example, the app publisher 150 (or a collection entity) sends the media ID 162 and the device/user identifier(s) 164 as impression data 170 to an impression collector 172 (e.g., an impression collection server or a data collection server) at the AME 102. The impression data 170 of the illustrated example may include one media ID 162 and one or more device/user identifier(s) 164 to report a single impression of the media 158, or it may include numerous media IDs 162 and device/user identifier(s) 164 based on numerous instances of collected data (e.g., the collected data 166) received from the client device 146 and/or other devices to report multiple impressions of media.

In the illustrated example, the impression collector 172 stores the impression data 170 in an AME media impressions store 174 (e.g., a database or other data structure). Subsequently, the AME 102 sends the device/user identifier(s) 164 to corresponding partner database proprietors (e.g., the partner database proprietors 106a-b) to receive user information (e.g., the user information 142a-b) corresponding to the device/user identifier(s) 164 from the partner database proprietors 106a-b so that the AME 102 can associate the user information with corresponding media impressions of media (e.g., the media 158) presented at the client device 146.

More particularly, in some examples, after the AME 102 receives the device/user identifier(s) 164, the AME 102 sends device/user identifier logs 176a-b to corresponding partner database proprietors (e.g., the partner database proprietors 106a-b). Each of the device/user identifier logs 176a-b may include a single device/user identifier 164, or it may include numerous aggregate device/user identifiers 164 received over time from one or more devices (e.g., the client device 146). After receiving the device/user identifier logs 176a-b, each of the partner database proprietors 106a-b looks up its users corresponding to the device/user identifiers 164 in the respective logs 176a-b. In this manner, each of the partner database proprietors 106a-b collects user information 142a-b corresponding to users identified in the device/user identifier logs 176a-b for sending to the AME 102. For example, if the partner database proprietor 106a is a wireless service provider and the device/user identifier log 176a includes IMEI numbers recognizable by the wireless service provider, the wireless service provider accesses its subscriber records to find users having IMEI numbers matching the IMEI numbers received in the device/user identifier log 176a. When the users are identified, the wireless service provider copies the users' user information to the user information 142a for delivery to the AME 102.

In some other examples, the data collector 152 is configured to collect the device/user identifier(s) 164 from the client device 146. The example data collector 152 sends the device/user identifier(s) 164 to the app publisher 150 in the collected data 166, and it also sends the device/user identifier(s) 164 to the media publisher 160. In such other examples, the data collector 152 does not collect the media ID 162 from the media 158 at the client device 146 as the data collector 152 does in the example system 142 of FIG. 1B. Instead, the media publisher 160 that publishes the media 158 to the client device 146 retrieves the media ID 162 from the media 158 that it publishes. The media publisher 160 then associates the media ID 162 to the device/user identifier(s) 164 received from the data collector 152 executing in the client device 146, and sends collected data 178 to the app publisher 150 that includes the media ID 162 and the associated device/user identifier(s) 164 of the client device 146. For example, when the media publisher 160 sends the media 158 to the client device 146, it does so by identifying the client device 146 as a destination device for the media 158 using one or more of the device/user identifier(s) 164 received from the client device 146. In this manner, the media publisher 160 can associate the media ID 162 of the media 158 with the device/user identifier(s) 164 of the client device 146 indicating that the media 158 was sent to the particular client device 146 for presentation (e.g., to generate an impression of the media 158).

In some other examples in which the data collector 152 is configured to send the device/user identifier(s) 164 to the media publisher 160, the data collector 152 does not collect the media ID 162 from the media 158 at the client device 146. Instead, the media publisher 160 that publishes the media 158 to the client device 146 also retrieves the media ID 162 from the media 158 that it publishes. The media publisher 160 then associates the media ID 162 with the device/user identifier(s) 164 of the client device 146. The media publisher 160 then sends the media impression data 170, including the media ID 162 and the device/user identifier(s) 164, to the AME 102. For example, when the media publisher 160 sends the media 158 to the client device 146, it does so by identifying the client device 146 as a destination device for the media 158 using one or more of the device/user identifier(s) 164. In this manner, the media publisher 160 can associate the media ID 162 of the media 158 with the device/user identifier(s) 164 of the client device 146 indicating that the media 158 was sent to the particular client device 146 for presentation (e.g., to generate an impression of the media 158). In the illustrated example, after the AME 102 receives the impression data 170 from the media publisher 160, the AME 102 can then send the device/user identifier logs 176a-b to the partner database proprietors 106a-b to request the user information 142a-b as described above.

Although the media publisher 160 is shown separate from the app publisher 150 in FIG. 1, the app publisher 150 may implement at least some of the operations of the media publisher 160 to send the media 158 to the client device 146 for presentation. For example, advertisement providers, media providers, or other information providers may send media (e.g., the media 158) to the app publisher 150 for publishing to the client device 146 via, for example, the app program 156 when it is executing on the client device 146. In such examples, the app publisher 150 implements the operations described above as being performed by the media publisher 160.

Additionally or alternatively, in contrast with the examples described above in which the client device 146 sends identifiers to the audience measurement entity 102 (e.g., via the application publisher 150, the media publisher 160, and/or another entity), in other examples, the client device 146 (e.g., the data collector 152 installed on the client device 146) sends the identifiers (e.g., the device/user identifier(s) 164) directly to the respective database proprietors 106a, 106b (e.g., not via the AME 102). In some such examples, the example client device 146 sends the media identifier 162 to the audience measurement entity 102 (e.g., directly or through an intermediary such as via the application publisher 150), but does not send the media identifier 162 to the database proprietors 106a-b.

As mentioned above, the example partner database proprietors 106a-b provide the user information 142a-b to the example AME 102 for matching with the media identifier 162 to form media impression information. As also mentioned above, in some examples, the database proprietors 106a-b are not provided copies of the media identifier 162. In such examples, the client device 146 provides the database proprietors 106a-b with impression identifiers 180. An impression identifier uniquely identifies an impression event relative to other impression events of the client device 146 so that an occurrence of an impression at the client device 146 can be distinguished from other occurrences of impressions. However, the impression identifier 180 does not itself identify the media associated with that impression event. In such examples, the impression data 170 from the client device 146 to the AME 102 also includes the impression identifier 180 and the corresponding media identifier 162. To match the user information 142a-b with the media identifier 162, the example partner database proprietors 106a-b provide the user information 142a-b to the AME 102 in association with the impression identifier 180 for the impression event that triggered the collection of the user information 142a-b. In this manner, the AME 102 can match the impression identifier 180 received from the client device 146 to a corresponding impression identifier 180 received from the partner database proprietors 106a-b to associate the media identifier 162 received from the client device 146 with demographic information in the user information 142a-b received from the database proprietors 106a-b. The impression identifier 180 can additionally be used for reducing or avoiding duplication of demographic information. For example, the example partner database proprietors 106a-b may provide the user information 142a-b and the impression identifier 180 to the AME 102 on a per-impression basis (e.g., each time a client device 146 sends a request including an encrypted identifier 164a-b and an impression identifier 180 to the partner database proprietor 106a-b) and/or on an aggregated basis (e.g., send a set of user information 142a-b, which may include indications of multiple impressions (e.g., multiple impression identifiers 180), to the AME 102 presented at the client device 146).

The impression identifier 180 provided to the AME 102 enables the AME 102 to distinguish unique impressions and avoid over counting a number of unique users and/or devices viewing the media. For example, the relationship between the user information 142a from the partner A database proprietor 106a and the user information 142b from the partner B database proprietor 106b for the client device 146 is not readily apparent to the AME 102. By including an impression identifier 180 (or any similar identifier), the example AME 102 can associate user information corresponding to the same user between the user information 142a-b based on matching impression identifiers 180 stored in both of the user information 142a-b. The example AME 102 can use such matching impression identifiers 180 across the user information 142a-b to avoid over counting mobile devices and/or users (e.g., by only counting unique users instead of counting the same user multiple times).

A same user may be counted multiple times if, for example, an impression causes the client device 146 to send multiple device/user identifiers to multiple different database proprietors 106a-b without an impression identifier (e.g., the impression identifier 180). For example, a first one of the database proprietors 106a sends first user information 142a to the AME 102, which signals that an impression occurred. In addition, a second one of the database proprietors 106b sends second user information 142b to the AME 102, which signals (separately) that an impression occurred. In addition, separately, the client device 146 sends an indication of an impression to the AME 102. Without knowing that the user information 142a-b is from the same impression, the AME 102 has an indication from the client device 146 of a single impression and indications from the database proprietors 106a-b of multiple impressions.

To avoid over counting impressions, the AME 102 can use the impression identifier 180. For example, after looking up user information 142a-b, the example partner database proprietors 106a-b transmit the impression identifier 180 to the AME 102 with corresponding user information 142a-b. The AME 102 matches the impression identifier 180 obtained directly from the client device 146 to the impression identifier 180 received from the database proprietors 106a-b with the user information 142a-b to thereby associate the user information 142a-b with the media identifier 162 and to generate impression information. This is possible because the AME 102 received the media identifier 162 in association with the impression identifier 180 directly from the client device 146. Therefore, the AME 102 can map user data from two or more database proprietors 106a-b to the same media exposure event, thus avoiding double counting.

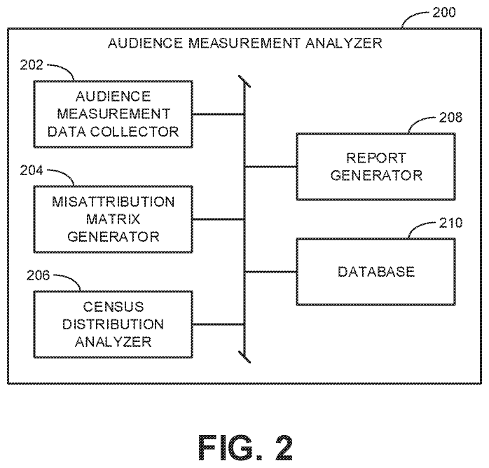

FIG. 2 is a block diagram illustrating an example implementation of the example audience measurement analyzer 200 of FIGS. 1A and 1B to estimate true census distributions for media impressions based on misattributed census data obtained from a database proprietor 106. The example audience measurement analyzer 200 includes an example audience measurement data collector 202, an example misattribution matrix generator 204, an example census distribution analyzer 206, an example report generator 208, and an example database 210.

In the illustrated example of FIG. 2, the audience measurement data collector 202 collects audience measurement data from one or more of the database proprietors 106 of FIGS. 1A and/or 1B. Audience measurement data collected from database proprietors is sometimes referred to herein as census data because it is based on data from audience members throughout the entire population of interest regardless of whether the audience members have enrolled in an audience measurement panel. In some examples, the audience measurement data collector 202 receives the audience measurement data in an aggregated or summary form. More particularly, in some examples, the audience measurement data from the database proprietor 106 expresses the number of media impressions by one or more individuals associated with one of two or more demographic characteristics. In other words, the audience measurement data is representative of a distribution of impressions across multiple demographic characteristics. The distribution provided by the database proprietor 106 is referred to herein as a misattributed census distribution because the data is provided on a census-wide level (e.g., based on data from audience members regardless of whether they are panelists) but does not account for misattribution of impressions between different ones of the demographic characteristics represented in the distribution. An example misattributed census distribution (F) across three demographic characteristics (demo₁, demo₂, and demo₃) is provided as follows:

$$F = [ \begin{matrix}{demo}_{1} \\ {demo}_{2} \\ {demo}_{3}\end{matrix} ] = [ \begin{matrix}69 \\ 93 \\ 39\end{matrix} ] \qquad Eq . 1$$

Each value in the misattributed census distribution (F) represents the number of impressions credited to audience members associated with the three different demographic characteristics. That is, 69 impressions were reported as being associated with the first demographic characteristic (demo₁), 93 impressions were reported as being associated with the second demographic characteristic (demo₂), and 39 impressions were reported as being associated with the third demographic characteristic (demo₃). The values in the example misattributed census distribution are selected for simplicity of explanation in the examples outlined below. However, in many instances, particularly where a relevant population is relatively large, the number of impressions may be much larger (e.g., number in the tens of thousands or more). The particular demographic characteristics represented by each of the three numbers in the example misattributed census distribution of Equation 1 above may correspond to any suitable demographic characteristics. For example, the impressions may be divided across different demographic characteristics corresponding to one or more of gender, age, race, ethnicity, income bracket, geographic location, educational level, etc. Furthermore, in some examples, the impressions may be divided across fewer (e.g., two) or more (e.g., four or more) demographic characteristics.

Additionally, in the illustrated example of FIG. 2, the example audience measurement data collector 202 collects audience measurement data from panelists and/or panelist households associated with the AME 102. Audience measurement data collected from panelists is sometimes referred to herein as panelist data to distinguish it from the census data collected from database proprietors. As described above, the audience measurement data collected from panelists includes specific details regarding who was exposed to (e.g., had an impression) of different media items. This detailed information may be associated with demographic information that was previously collected by the AME 102 (e.g., when the panelists initially joined the panel) and corresponds to the panelists identified as being exposed to the relevant media items. In some examples, the audience measurement data collected from panelists (e.g., panelist data) and/or from a database proprietor 106 (e.g., census data) is stored in the example database 210.

Based on the detailed information collected by the AME 102, the example misattribution matrix generator 204 may generate a misattribution matrix, which may be stored in the example database 210. As used herein, a misattribution matrix is a matrix that represents both (1) the number of impressions actually experienced by panelists associated with different demographic characteristics and (2) the number of impressions experienced by panelists that would be attributed or credited to an individual associated with different demographics if reported by a database proprietor (e.g., the database proprietor 106). That is, the misattribution matrix represents both (1) the actual or correct crediting of impressions (i.e., accounts for misattribution) and (2) the way in which audience measurement data from a database proprietor would categorize the impressions (i.e., without accounting for misattribution). An example misattribution matrix (M) that includes 10,000 audience member panelists divided across three demographic characteristics is provided as follows:

$$M = [ \begin{matrix}D 1 & D 2 \to D 1 & D 3 \to D 1 \\ D 1 \to D 2 & D 2 & D 3 \to D 2 \\ D 1 \to D 3 & D 2 \to D 3 & D 3\end{matrix} ] = [ \begin{matrix}718 & 1759 & 1014 \\ 598 & 3741 & 64 \\ 567 & 396 & 1143\end{matrix} ] \qquad Eq . 2$$

where the elements on the diagonal (D1, D2, and D3) represent the impressions correctly attributed to demo₁, demo₂, and demo₃, respectively. The notation DX→DY represents impressions that should have been credited to the demo associated with X but would likely be misattributed to the demographic associated with Y. For example, D1→D2 represents the number of impressions that should be attributed to demo₁, but are likely to be incorrectly misattributed to demo₂.

In the example misattribution matrix M, the sum of each column represents the true number of impressions associated with the corresponding demographic characteristic. For example, the sum of the first column indicates a total of 718+598+567=1883 impressions actually experienced by panelists associated with the first demographic characteristic. Of these 1883 impressions, the matrix indicates that 718 (listed in the first row) would properly be attributed to the first demographic by a database proprietor, with 598 (listed in the second row) incorrectly being attributed to the second demographic and 567 (listed in the third row) incorrectly being attributed to the third demographic.

Further, in the example misattribution matrix M, the sum of each row represents the number of impressions that would likely be reported by a database proprietor without accounting for misattribution. That is, the sum of each row of the misattribution matrix M corresponds to the values represented in the misattributed census distribution F of Equation 1 described above except the rows in the misattribution matrix M are limited to panelists rather than being census wide. As mentioned above, the values in the misattributed census distribution F were selected for simplicity of explanation. However, in most situations, the values in the misattributed census distribution F are much higher than the values in the misattribution matrix M because the matrix M is limited to audience member panelists whereas the census distribution F corresponds to an entire population subject to the audience measurement. In any event, in the example misattribution matrix M of Equation 2 above, the sum of the first row indicates a total of 718+1759+1014=3491 impressions that would be reported from a database proprietor as being experienced by panelists associated with the first demographic characteristic. Of these 3491 impressions, the matrix indicates that 718 (listed in the first column) would be properly attributed to the first demographic, with 1759 (listed in the second column) incorrectly being attributed to the second demographic and 1014 (listed in the third column) incorrectly being attributed to the third demographic.

As mentioned above, the example misattribution matrix M of Equation 2 above is generated based on panelist data rather than audience measurement census data collected by a database proprietor. As such, the misattribution of impressions between the different demographic characteristics is based on assumptions about how the database proprietor associates a particular impression with a particular individual rather than what a database proprietor has actually reported. As described above, database proprietors often associate a particular impression based on cookie information and/or other user information associated with a particular client device that accessed media. Because impressions tracked by a database proprietor are based on cookies and/or other user information, the database proprietor cannot determine when an individual other than the user associated with the cookie and/or other user information was using the particular client device thereby giving rise to the misattribution outlined above. The misattribution matrix generator 204 is able to generate the above misattribution matrix M because the detailed panelist data collected by the AME 102 and obtained by the audience measurement data collector 202 includes both cookie/user information and additional information to uniquely identify the user of a media device.

The number of impressions actually experienced by panelists associated with the first demographic in the above misattribution matrix M (e.g., 1883 impressions) is significantly less than the number of impressions that are likely to be reported in audience measurement data collected from database proprietors (e.g., 3491 impressions). This suggests that actual audience measurement census data collected from a database proprietor such as, for example, the data represented in the misattributed census distribution F cannot be trusted as indicating the actual distribution of impressions. Accordingly, the example audience measurement analyzer 200 is provided with the example census distribution analyzer 206 to correct the misattributed census distribution to account and/or correct for misattribution.

Various approaches have been attempted in the past to estimate a true census distribution (e.g., that accounts for misattribution) based on a misattributed census distribution F obtained from a database proprietor 106 and a misattribution matrix M generated based on panelist data. An example first prior approach involves applying Bayes' theorem by conditioning the misattribution matrix M along the rows to determine the probability of where each demographic-specific impression reported in the misattributed census distribution F would have come from (if properly attributed) and then aggregate the totals. The resulting estimate for a true census distribution (G) can be computed directly by normalizing the misattribution matrix M across each row (based on the corresponding sum for the row), transposing the normalized matrix, and multiplying it by the misattributed census distribution F as follows:

$$G = [ \begin{matrix}\frac{718}{3401} & \frac{598}{4403} & \frac{567}{2106} \\ \frac{1759}{3401} & \frac{3741}{4403} & \frac{396}{2106} \\ \frac{1014}{3401} & \frac{64}{4403} & \frac{1143}{2106}\end{matrix} ] [ \begin{matrix}69 \\ 93 \\ 39\end{matrix} ] = [ \begin{matrix}37 \\ 121 \\ 43\end{matrix} ] \qquad Eq . 3$$

The above estimation of the true census distribution G indicates the actual number of impressions associated with the first demographic characteristic should be 37 (rather than 69 as reported in the misattributed census distribution F), the number of impressions associated with the second demographic characteristic should be 121 (rather than 93), and the number of impressions associated with the third demographic characteristic should be 43 (rather than 39). To test the validity of this approach, small variations in the misattributed census distribution F can be entered in the above analysis and the results compared to determine the amount of variation between the different resulting true census distributions G. For example, the following misattributed census distributions:

$${F}_{0} = [ \begin{matrix}69 \\ 93 \\ 39\end{matrix} ] {F}_{1} = [ \begin{matrix}70 \\ 93 \\ 39\end{matrix} ] {F}_{2} = [ \begin{matrix}69 \\ 94 \\ 39\end{matrix} ] {F}_{3} = [ \begin{matrix}69 \\ 93 \\ 40\end{matrix} ]$$

produce the resulting estimate for the corresponding true census distributions:

$${G}_{0} = [ \begin{matrix}37 \\ 121 \\ 43\end{matrix} ] {G}_{1} = [ \begin{matrix}38 \\ 121 \\ 43\end{matrix} ] {G}_{2} = [ \begin{matrix}37 \\ 122 \\ 43\end{matrix} ] {G}_{3} = [ \begin{matrix}38 \\ 121 \\ 43\end{matrix} ]$$

where F₀ corresponds to the misattributed census distribution F described above at Equation 1, F₁ corresponding to the misattributed census distribution F in which the impression count for the first demographic characteristic (demo₁) is incremented by one, F₂ corresponding to the misattributed census distribution F in which the impression count for the second demographic characteristic (demo₂) is incremented by one, and F₃ corresponding to the misattributed census distribution F in which the impression count for the third demographic characteristic (demo₃) is incremented by one. As can be seen, small variations in the input data (e.g., the misattributed census distribution F) result in small corresponding variations in the associated output (e.g., the estimated true census distribution G).

The above analysis suggests that the application of Bayes' theorem along the rows of the misattribution matrix M produces reasonable results that are reliable. However, the above methodology involves adapting an assumption in the application of Bayes' theorem that the distribution of the population that was used to create the misattribution matrix M is the same distribution of the population of the audience at the census-level that was exposed to the particular media item being analyzed. As noted above, the misattribution matrix M was generated based on panelist data. Thus, the above assumption asserts that the distribution of the demographic characteristics across the population corresponding to the panelists is the same as the distribution of the demographic characteristics across the entire population of audience members that were exposed to the corresponding media. This assumption can be problematic in situations in which the demographic distribution of audience members exposed to a first media item (e.g., an advertisement targeting Disney viewers) is different than the demographic distribution of audience members exposed to a second, different media item (e.g., an advertisement targeting alcohol enthusiasts). In such scenarios, applying Bayes' theorem as described above to the collected data causes a computer to produce results of less accuracy than results produced by computers configured to employ techniques disclosed herein.

A second prior technique applies Bayes' theorem in the other direction. That is, rather than conditioning and normalizing a misattribution matrix M across the rows, the matrix M is conditioned and normalized down the columns. This prior technique conditions the data on one demographic characteristic at a time to determine how a given impression from the census data (e.g., in the misattributed census distribution F) may be misattributed to any one of the other demographics. This approach eliminates the assumption outlined above for the first approach, but it relies on a different assumption. In particular, this alternate second prior approach assumes that the misattributed census distribution F, conditioned on a true demographic characteristic, does not change if the structure of the population distribution changes. That is, whether the true demographic distribution of a population is 40% male or 70% male, a given impression from a male within the population is assumed to be misattributed across the demographic characteristics using the same probabilities (e.g., 60% for the first demographic, 20% for the second demographic, and 20% for the third demographic) regardless of how many males (or other demographic numbers) are in the population. Although this assumption is not necessarily true, it is not as strict as the assumption in the first prior approach and enables the subsequent analysis without requiring more complex models where the actual conditional misattribution for each demographic is a function of the unknown true demographic distributions themselves.

Following the above assumption of the second prior technique, the misattribution matrix generator 204 may generate a column-conditioned misattribution matrix (C) by normalizing the misattribution matrix M down the columns as shown in Equation 4 below using the example matrix M provided in Equation 2 above:

$$C = [ \begin{matrix}\frac{718}{1883} & \frac{1759}{5896} & \frac{1014}{2221} \\ \frac{598}{1883} & \frac{3741}{5896} & \frac{64}{2221} \\ \frac{567}{1883} & \frac{396}{5896} & \frac{1143}{2221}\end{matrix} ] = [ \begin{matrix}0.3813 & 0.2983 & 0.4566 \\ 0.3176 & 0.6345 & 0.0288 \\ 0.3011 & 0.0672 & 0.5146\end{matrix} ] \qquad Eq . 4$$

Inserting the column-conditioned misattribution matrix C and the misattributed census distribution F into the following Equation 5, the true census distribution G can be solved for:

CG=F Eq. 5

Assuming F=F₀ provided in the above examples, the solution is shown in Equation 6 below:

$${G}_{0} = [ \begin{matrix}72 \\ 110 \\ 19\end{matrix} ] \qquad Eq . 6$$

To test the validity of this approach, small variations in the misattributed census distribution F can be entered in the above analysis and the results compared to determine the amount of variation between the different resulting true census distributions G. For example, the following misattributed census distributions:

$${F}_{0} = [ \begin{matrix}69 \\ 93 \\ 39\end{matrix} ]$$

$${F}_{1} = [ \begin{matrix}70 \\ 93 \\ 39\end{matrix} ]$$

$${F}_{2} = [ \begin{matrix}69 \\ 94 \\ 39\end{matrix} ]$$

$${F}_{3} = [ \begin{matrix}69 \\ 93 \\ 40\end{matrix} ]$$

produce the resulting estimates for corresponding true census distributions:

$${G}_{0} = [ \begin{matrix}72 \\ 110 \\ 19\end{matrix} ]$$

$${G}_{1} = [ \begin{matrix}2978 \\ - 1276 \\ - 1500\end{matrix} ]$$

$${G}_{2} = [ \begin{matrix}- 1028 \\ 636 \\ 594\end{matrix} ]$$

$${G}_{3} = [ \begin{matrix}- 2445 \\ 1309 \\ 1337\end{matrix} ]$$

As can be seen, small variations in the input data (i.e., the misattributed census distribution F) result in large variations in the associated output data (e.g., the estimated true census distribution G) that are unreliable. The underlying issue with the second approach, in a linear algebra sense, is that the determinant of the column-conditioned matric C is close to zero such that the output is very sensitive to the input. Another problem with this approach is that in some situations the output can include negative values for the impressions associated with particular demographic characteristics, which make no sense because it is not possible to have a negative number of impressions. Additionally or alternatively, some positive values for impressions are greater than the total number of impressions reported across all three demographic characteristics, which is also nonsensical as an impossibility. This demonstrates that this second approach can also be unreliable.

A problem of this second prior approach can be further demonstrated with reference to the inverse of C shown below:

$${C}^{- 1} = [ \begin{matrix}2906 & - 1100 & - 2517 \\ - 1386 & 526 & 1200 \\ - 1520 & 575 & 1318\end{matrix} ] \qquad Eq . 7$$

The values in the inverse of the column-conditioned misattribution matrix C are supposed to be representative of probabilities and, therefore, should be between 0 and 1. While each column correctly sums to 1, the individual elements of the matrix make no sense such that there is no basis to expect the final output to be indicative of a true census distribution.

It can be shown mathematically that the only class of matrices which has probabilities (e.g., values between 0 and 1) as elements within and whose inverse elements are also probabilities is a permutation of the identity matrix. That is not the case when tracking impressions across different demographics at issue in this problem. Therefore, in some situations, this second prior approach produces results that are less accurate than results produced by techniques disclosed herein. Previous implementations of this second prior approach have attempted to overcome the above problems by using singular value decomposition and/or other linear algebra techniques to arrive at solutions that are reasonable. However, results can sometimes still exhibit low accuracy in representing the actual distribution of impressions.

Examples disclosed herein overcome the limitations of the prior approaches by going beyond inverting a probability matrix by applying a particular probability model. In particular, in some examples, the analysis by the example census distribution analyzer 206 of FIG. 2 assumes that the column-conditioned misattribution matrix C is correct such that a given impression associated with demo i (e.g., the ith demographic characteristic) in the census data is distributed by probabilities p₁, p₂, . . . pₘ that sum to 1 (where k corresponds to the number of different demographic characteristics across which the impressions are distributed). With this assumption, the column-conditioned misattribution matrix C can be thought of as a set of partitioned probability vectors

c=[p⁽¹⁾|p⁽²⁾| . . . |p^{(m)}] Eq. 8

where m is the number of different demographic characteristics across which the impressions are distributed, and p⁽ⁱ⁾ is a column vector of length m showing how the true number of impressions associated with demo i is distributed across the m demographics.

For purposes of explanation, assume that one of the demographic characteristics (e.g., demo i) was truly associated with n⁽ⁱ⁾ impressions. The manner in which those impressions are misattributed to the other demographics follows a multinomial distribution expressed as follows

$$f ( {x}_{1} , … , {x}_{m} ; n , {p}_{1} , … , {p}_{m} ) = PR ( {X}_{1} = {x}_{1} and … and {X}_{m} = {x}_{m} ) = \{ \begin{matrix}\frac{n !}{{x}_{1} ! … {x}_{m} !} {p}_{1}^{{x}_{1}} \times … \times {p}_{m}^{{x}_{m}} , & when {\sum }_{i = 1}^{m} {x}_{i} = n \\ 0 , & otherwise\end{matrix} \qquad Eq . 9$$

As a specific example, if the probability of misattribution of impressions associated with a particular demographic is p=[0.3, 0.2, 0.5], the probability that 10 impressions actually associated with the first demographic characteristic would be misattributed as x=[4, 1, 5] would be 6.38% as shown in Equation 10 below:

$$\frac{( 10 ! )}{( 4 ! ) ( 1 ! ) ( 5 ! )} {( 0.3 )}^{4} {( 0.2 )}^{1} {( 0.5 )}^{5} = 6.378 \% \qquad Eq . 10$$

However, the probability for a particular distribution of impressions cannot be determined from the available data in this manner because the available data (e.g., the census data) is limited to aggregated totals of misattributed impressions across all the demographic characteristics such that the particular distribution of impressions associated with a particular demographic is not known. Accordingly, the distribution of impressions for each demographic characteristic can be computed as shown in Equation 11 below.

X⁽ⁱ⁾˜Multi(n⁽ⁱ⁾,p⁽ⁱ⁾) such that Σᵢ n⁽ⁱ⁾=n Eq. 11

The final distribution of all impressions as the probabilistic sum across all combinations for each of the demographic-specific distributions as shown below in Equation 12 below.

Z˜X⁽¹⁾+ . . . +X^{(m)}=⊕ᵢ₌₁^{m}X⁽ⁱ⁾ Eq. 12

A processor can use the final distribution calculated based on Equation 12 above to find the set of n⁽ⁱ⁾ impressions that maximizes the likelihood of seeing the observed data (e.g., the aggregated totals in the misattributed census distribution F).

While the above approach can be used to arrive at an accurate estimate of a true census distribution G based on a given misattributed census distribution F, the approach is problematic because there is no closed form answer for such a probability (even for two demographic characteristics and binomial assignment). Furthermore, calculating the solution is not possible as a practical matter because of combinatorial explosion. Combinatorial explosion is the rapid growth of complexity of a problem due to the number of combinations that are to be analyzed to solve the problem. Combinatorial explosion limits the ability to solve certain types of large problems.

For example, assume the test case of a possible solution for the true census distribution G across three demographic characteristics with impressions divided as {30; 20; 50} with some known misattribution probabilities that is to produce an expected outcome of {40; 40; 20} (defined by the known misattributed census distribution F). There are 496 ways to distribute 30 impressions across three demographics, 231 ways for 20 impressions, and 1,326 ways for 50 impressions, resulting in a total of 151,927,776 possible combinations. However, some combinations produce the same answer when aggregated together. In particular, there are 5,151 unique answers of which one of them will produce the known misattributed census distribution of {40; 40; 20}. Calculating the likelihood of seeing {40; 40; 20} involves adding the probabilities of the 76,186 combinations out of the 151,927,776 which aggregate to your observed data. This is only 1/20th of 1% of all combinations, yet all 76,186 combinations are needed to determine the probability. Implementing a Monte Carlo method to calculate these values, even 1,000,000 times, may only produce 500 of 76,186 required combinations. While the values for the 500 combinations may be sufficient to provide a reasonable estimate of the actual probability of seeing {40; 40; 20}, this process only tests for the particular possible solution of impressions distributed as {30; 20; 50}. To determine an accurate estimate of the true census distribution G, every other possible distribution of the impressions is also analyzed. That is, in addition to calculating the probability of producing {40; 40; 20} based on {30; 20; 50}, the process is repeated based on {31; 20; 50}, {29; 21; 52}, {0; 0; 100}, etc. In this example, the process is repeated a total of 5,151 times. Furthermore, the above numbers are for the case of n=100 impressions, a relatively small number. If, instead, the number of impressions is n=100,000 impressions distributed across 10 demographic characteristics, there are a total of 2.75×10\hat{ }39 possible census distributions to test. Such combinatorial explosion renders the above approach computationally impractical.

The above process can be computationally simplified if the assignment of impressions to the different demographic characteristics occurs after the misattribution. That is, instead of assigning impressions to the true demographics (by generating each possible combination of impressions divided across the different demographics) and applying misattribution in each case based on the multinomial model and then aggregating those impressions, in some examples, a particular census distribution model is assumed for the true census data. The misattribution probabilities for the model can be calculated to then determine the likelihood of producing the known misattributed census distribution F.

For example, assume the column-conditioned misattribution matrix C provided above has been calculated as shown in Equation 4 and the misattributed census distribution F is [69, 92, 39] as provided above in Equation 1. Further, assume that a census distribution model (T) is randomly generated as [0.3582, 0.5473, 0.0945] as a possible distribution corresponding to the true census distribution G for the census impressions. Multiplying the column-conditioned misattribution matrix C by the census distribution model T produces the probability vector (P) of [0.3430, 0.4637, 0.1933] that corresponds to the expected distribution of the observed data (i.e., the misattributed census distribution F). The likelihood that the census distribution model T actually corresponds to the true census distribution can be calculated by inputting the above values into the multinomial distribution of Equation 9, which in this example, results in 0.45% as shown in Equation 13 below:

$$\frac{( 200 ! )}{( 69 ! ) ( 92 ! ) ( 39 ! )} {( 0.3430 )}^{69} {( 0.4637 )}^{92} {( 0.1933 )}^{39} = 0.0045 \qquad Eq . 13$$

Repeating this process for many different census distribution models can be implemented to facilitate the determination of the true census distribution. However, the final true census distribution cannot be determined simply by finding the distribution model that maximizes the likelihood because there are certain observed values (e.g., the misattributed census distribution F) that may force the optimization to be an edge case (e.g., either 0% or 100%) and remain there regardless of changes to the inputs. As shown below in Equation 14, slight changes to the estimated census distribution model T and/or the corresponding probability vector P (e.g., change P to [0.35, 0.45, 0.2] produce a slight change in the output likelihood.

$$\frac{( 200 ! )}{( 69 ! ) ( 92 ! ) ( 39 ! )} {( 0.35 )}^{69} {( 0.45 )}^{92} {( 0.2 )}^{39} = 0.0043 \qquad Eq . 14$$

This result of variation to the output based on variations to the inputs occurs when the likelihood is near the maximum. As a result, if the maximum likelihood estimate is based on a point estimate, the likelihood of models near (but not actually at) the maximum would be discarded. To avoid this issue, in some examples, the census distribution analyzer 206 averages across all possible distribution models while weighing each model according to its corresponding likelihood to reproduce the observed misattributed census distribution F. In this manner, a reasonable and reliable estimate of the true census distribution G can be determined in a way that considers all possible census distribution models.

In some examples, the census distribution analyzer 206 implements model averaging using Bayes' theorem in light of given data corresponding to the misattributed census distribution F. In particular, Bayes' theorem may be used to calculate the posterior probability of some test data ( [symbol] ) being correct given some prior data ( [symbol] ). In examples disclosed herein, the test data [symbol] corresponds to the different possible census distribution models T and the prior data [symbol] corresponds to the aggregated statistics provided in the misattributed census distribution F. Bayes' theorem can be expressed mathematically as shown in Equation 15 below.

$$\begin{matrix}P ( {𝒥}_{k} \vert 𝒟 ) = \frac{P ( {𝒥}_{k} 𝒟 )}{P ( 𝒟 )} \\ = \frac{P ( {𝒥}_{k} 𝒟 )}{{\sum }_{k} P ( {𝒥}_{k} 𝒟 )} \\ = \frac{P ( 𝒟 \vert {𝒥}_{k} ) P ( {𝒥}_{k} )}{{\sum }_{k} P ( 𝒟 \vert {𝒥}_{k} ) P ( {𝒥}_{k} )} \\ = \frac{P ( 𝒟 \vert {𝒥}_{k} ) P ( {𝒥}_{k} )}{{\sum }_{k} P ( 𝒟 \vert {𝒥}_{k} ) P ( {𝒥}_{k} )}\end{matrix} \qquad Eq . 15$$

In Equation 15 above, P( [symbol] ₖ) is the probability of selecting the kth test data [symbol] (e.g., a particular census distribution model T), and P(D| [symbol] ₖ) is the likelihood of seeing the observed data [symbol] (e.g., the misattributed census distribution F) given the particular census distribution model T being analyzed. In some examples, each census distribution model T used as test data [symbol] is randomly selected from a uniform Dirichlet distribution such that the probability P( [symbol] ₖ) is the same for every census distribution model T. Thus, the probability P( [symbol] ₖ) for any particular test case is equal to 1 divided by the total number of test cases analyzed. The likelihood of seeing the observed data given the particular census distribution model T (i.e., P ( [symbol] | [symbol] ₖ)) is calculated using the multinomial distribution defined in Equation 9 above.

With further reference to Equation 15 above, the term P( [symbol] | [symbol] ₖ) in the third line is replaced with the term P ( [symbol] | [symbol] ₖ) in the fourth line. Replacing [symbol] ₖ (corresponding to a census distribution model T) with [symbol] ₖ (corresponding to the conditional misattribution probabilities associated with the census distribution model T calculated as [symbol] ₖ=C [symbol] ₖ, where C is the column-conditioned misattribution matrix) in the conditioning is valid because the linear operator produces a unique solution for [symbol] ₖ for any [symbol] ₖ. With this substitution in Equation 15, it is possible to calculate the likelihood that each model ( [symbol] ₖ) analyzed corresponds to the true census distribution and then evaluate the weighted average of the ith probability corresponding to the analyzed models. With D corresponding to the random variable of the different demographic characteristics by which the impression data is divided, the probability that impressions correspond to a particular demographic characteristic (D=i) given the observed data ( [symbol] ) can be expressed as shown in Equation 16 below.

$$\begin{matrix}P ( D = i \vert 𝒟 ) = {\sum }_{k} P ( D = i \vert {𝒥}_{k} ) P ( {𝒥}_{k} \vert 𝒟 ) \\ = {\sum }_{k} {( {𝒥}_{k} )}_{( i )} P ( {𝒥}_{k} \vert 𝒟 )\end{matrix} \qquad Eq . 16$$

The substitution of ( [symbol] ₖ)₍ᵢ₎ for P(D=i| [symbol] ₖ) between the first and second lines in Equation 16 above shows that the probability of the correct demographic characteristic being the ith demographic, given a specific model (e.g., [symbol] ₖ), is equal to the value in which that model assigned the probability of the ith demographic. In examples, where an infinite number of models are analyzed, the summation of Equation 16 turns into an integral and the posterior probabilities turn into probability densities.

For purposes of illustration, the analysis performed by the census distribution analyzer 206 is demonstrated herein using the following example. In this example, the column-conditioned misattribution matrix C is assumed to be the same as outlined in Equation 4 above. That is,

$$C = [ \begin{matrix}0.3813 & 0.2983 & 0.4566 \\ 0.3176 & 0.6345 & 0.0288 \\ 0.3011 & 0.0672 & 0.5146\end{matrix} ] \qquad Eq . 17$$

Further, in this example, the prior observed data (e.g., the misattributed census distribution) corresponds to the misattributed census distribution F₁ provided above and is reproduced in Equation 18 below.

$${F}_{1} = [ \begin{matrix}70 \\ 93 \\ 39\end{matrix} ] \qquad Eq . 18$$

This particular misattributed census distribution is selected for purposes of comparison relative to the method described above using the inverse of matrix C, which produced nonsensical results in the estimated true census distribution G1 that had negative numbers for impressions and positive numbers that exceeded the total number of impressions actually observed across all demographics.

With the above established as known information, in this example, the census distribution analyzer 206 generates five different test cases (e.g., census distribution models [symbol] ₖ) with specific probabilities (P(D=i)) assigned to each demographic characteristic and a probability (P( [symbol] ₖ)) of each particular model being selected. The assigned probabilities for the five models are summarized in Table 1 below.

TABLE 1
Assigned Values for Each Test Case

| | P (D = 1) | P (D = 2) | P (D = 3) | P ( [symbol] ₖ) |
|---|---|---|---|---|
| [symbol] | 0.40 | 0.40 | 0.20 | 0.2 |
| [symbol] | 0.50 | 0.50 | 0.00 | 0.2 |
| [symbol] | 0.50 | 0.40 | 0.10 | 0.2 |
| [symbol] | 0.40 | 0.50 | 0.10 | 0.2 |
| [symbol] | 0.25 | 0.50 | 0.25 | 0.2 |

For each test case [symbol] ₖ there is a unique misattribution probability vector [symbol] ₖ that may be calculated by applying the column-conditioned misattribution matrix (e.g., [symbol] ₖ←C( [symbol] Tₖ)). The results of this calculation for each test case are reproduced in Table 2 below.

TABLE 2
Misattribution Probabilities Corresponding to Each Test Case

| | P (D = 1) | P (D = 2) | P (D = 3) | P ( [symbol] ₖ) |
|---|---|---|---|---|
| [symbol] ₁ | 0.3632 | 0.3866 | 0.2502 | 0.2 |
| [symbol] ₂ | 0.3398 | 0.476 | 0.1841 | 0.2 |
| [symbol] ₃ | 0.3556 | 0.4155 | 0.2289 | 0.2 |
| [symbol] ₄ | 0.3473 | 0.4472 | 0.2055 | 0.2 |
| [symbol] ₅ | 0.3586 | 0.4038 | 0.2375 | 0.2 |

Following these calculations, the example census distribution analyzer 206 calculates the likelihood P( [symbol] | [symbol] ₖ) of seeing the observed data (e.g., the misattributed census distribution F₁) given the particular misattribution probabilities corresponding to each test case. In some examples, the example census distribution analyzer 206 calculates this value by evaluating the multinomial distribution of Equation 9. With the above likelihood determined, the example census distribution analyzer 206 applies Bayes' theorem, as outlined in Equation 15, to calculate the posterior probability P( [symbol] ₖ| [symbol] ) of each test case being correct given the observed data (e.g., the misattributed census distribution F₁). The result of these calculations for each test case is reproduced in Table 3 below.

TABLE 3
Likelihood of Observed Data given the Misattribution
Probabilities for Each Test Case and Corresponding Posterior
Probability of Each Test Case given the Observed Data

| | P ( [symbol] ₖ) | P ( [symbol] \| [symbol] ₖ) | P ( [symbol] ₖ \| [symbol] ) |
|---|---|---|---|
| [symbol] ₁ | 0.2 | 0.0003 | 0.0245 |
| [symbol] ₂ | 0.2 | 0.0040 | 0.3799 |
| [symbol] ₃ | 0.2 | 0.0015 | 0.1416 |
| [symbol] ₄ | 0.2 | 0.0040 | 0.3769 |
| [symbol] ₅ | 0.2 | 0.0008 | 0.0770 |

With these values determined for each test case, the example census distribution analyzer 206 calculates a weighted average across the demographic characteristic probabilities for each test case conditioned on the observed data by evaluating Equation 16. The results of these calculations correspond to the expected value for the true distribution and are reproduced in Table 4 below.

TABLE 4
Expected Values of True Distribution Based on Sum of Weighted
Averages of Probabilities for Different Demographic Characteristics
Conditioned on the Observed Data

| | P (D = 1) | P (D = 2) | P (D = 3) | P ( [symbol] ₖ \| [symbol] ) |
|---|---|---|---|---|
| [symbol] | 0.40 | 0.40 | 0.20 | 0.0245 |
| [symbol] | 0.50 | 0.50 | 0.00 | 0.3799 |
| [symbol] | 0.50 | 0.40 | 0.10 | 0.1416 |
| [symbol] | 0.40 | 0.50 | 0.10 | 0.3769 |
| [symbol] | 0.25 | 0.50 | 0.25 | 0.0770 |
| E [D] | 0.4406 | 0.4834 | 0.0760 | |

Multiplying the expected value E[D] for each demographic by the total number of impressions observed (e.g., in this case 70+93+39=202 impressions) provides the final estimate for the true census distribution of G₁ shown in Equation 19 below

$${G}_{1} = [ \begin{matrix}89 \\ 98 \\ 15\end{matrix} ] \qquad Eq . 19$$

which is clearly much more reasonable than the nonsensical result of G₁=[2978, −1276, −1500] that was calculated using the inverse of the column-conditioned misattribution matrix C as described above. Thus, as can be seen, the above approach can arrive at suitable estimates for a true census distribution without needing to burden a processor system with using its computing resources to implement singular value decomposition and/or other linear algebra techniques as was implemented in prior approaches to this problem.

The above example is based on an analysis of five census distribution models. As more models are added to the analysis, the expected value for the final census distribution converges to a better estimate of the true census distribution. Thus, as the number of models analyzed approach infinity, all possible considerations of the true distribution are taken into account to give a reliable estimate of the true census distribution. The limit of an infinite number of models may be approximated by implementing the process on a computer that analyzes a larger number of models in a vectorized fashion than would be possible for humans to perform in their minds and/or using pen and paper (e.g., at least 100,000 models). For example, implementing the above process with 1,000,000 selected models from the uniform Dirichlet using inputs based on the example misattributed census distributions described above:

$${F}_{0} = [ \begin{matrix}69 \\ 93 \\ 39\end{matrix} ]$$

$${F}_{1} = [ \begin{matrix}70 \\ 93 \\ 39\end{matrix} ]$$

$${F}_{2} = [ \begin{matrix}69 \\ 94 \\ 39\end{matrix} ]$$

$${F}_{3} = [ \begin{matrix}69 \\ 93 \\ 40\end{matrix} ]$$

produces the resulting estimates for the corresponding true census distributions:

$${G}_{0} = [ \begin{matrix}37 \\ 121 \\ 43\end{matrix} ]$$

$${G}_{1} = [ \begin{matrix}38 \\ 121 \\ 43\end{matrix} ]$$

$${G}_{2} = [ \begin{matrix}37 \\ 122 \\ 43\end{matrix} ]$$

$${G}_{3} = [ \begin{matrix}38 \\ 121 \\ 43\end{matrix} ]$$

As can be seen, the output estimates do not result in unreasonable and/or nonsensical results but include appropriate outputs that vary slightly based on slight variations to the inputs. Furthermore, it can be proven that the outputs are a continuous function of the inputs.

Examples disclosed herein equally take into account substantially all possible variations (e.g., 1,000,000 models is a reasonable approximation of all possible variations, which are technically infinite) for the census distribution and then determine the likelihood that each model could have replicated the observed data. The misattribution probabilities across all models are then averaged using the respective likelihoods for the models as weights to determine the final expected values for the different demographic characteristics from which the final true census distribution may be estimated.

In some examples, the census distribution analyzer 206 determines an estimated covariance matrix by using each model along with its corresponding likelihood as inputs to a weighted covariance formula. The covariance matrix may be used to calculate variances for impressions associated with each demographic characteristic and to calculate the correlations between such. In this manner, the census distribution analyzer 206 may generate confidence intervals (e.g., Bayesian Credibility Intervals).

In some examples, the final output and/or any of the intermediate values calculated by the census distribution analyzer 206 as outlined above may be stored in the example database 210. Further, in some examples, the report generator 208 shown in FIG. 2 generates any suitable report conveying any relevant information including the initially collected audience measurement information, the intermediate values calculated by the census distribution analyzer 206, the final estimate for the true census distribution, the estimated covariance matrix, and/or associated variances, correlations, and/or confidence intervals.

While an example manner of implementing the audience measurement analyzer 200 of FIGS. 1A and/or 1B is illustrated in FIG. 2, one or more of the elements, processes and/or devices illustrated in FIG. 2 may be combined, divided, re-arranged, omitted, eliminated and/or implemented in any other way. Further, the example audience measurement data collector 202, the example misattribution matrix generator 204, the example census distribution analyzer 206, the example report generator 208, the example database 210 and/or, more generally, the example audience measurement analyzer 200 of FIG. 2 may be implemented by hardware, software, firmware and/or any combination of hardware, software and/or firmware. Thus, for example, any of the example audience measurement data collector 202, the example misattribution matrix generator 204, the example census distribution analyzer 206, the example report generator 208, the example database 210 and/or, more generally, the example audience measurement analyzer 200 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example audience measurement data collector 202, the example misattribution matrix generator 204, the example census distribution analyzer 206, the example report generator 208, and/or the example database 210 is/are hereby expressly defined to include a non-transitory computer readable storage device or storage disk such as a memory, a digital versatile disk (DVD), a compact disk (CD), a Blu-ray disk, etc. including the software and/or firmware. Further still, the example audience measurement analyzer 200 of FIGS. 1A and/or 1B may include one or more elements, processes and/or devices in addition to, or instead of, those illustrated in FIG. 2, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

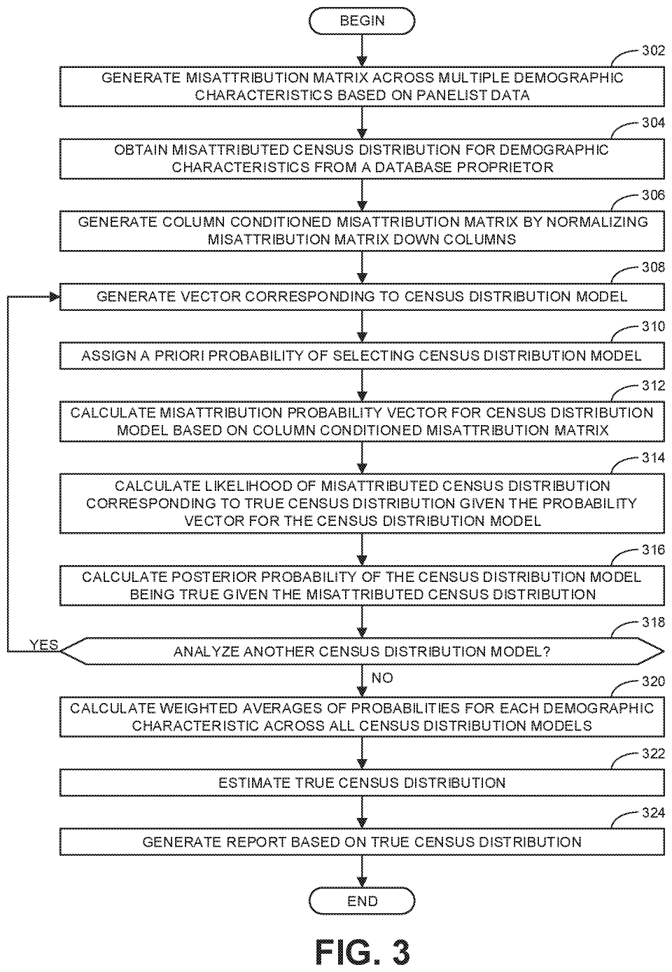

A flowchart representative of example hardware logic, machine readable instructions, hardware implemented state machines, and/or any combination thereof for implementing the audience measurement analyzer 200 of FIGS. 1A, 1B, and/or 2 is shown in FIG. 3. The machine readable instructions may be an executable program or portion of an executable program for execution by a computer processor such as the processor 512 shown in the example processor platform 500 discussed below in connection with FIG. 5. The program may be embodied in software stored on a non-transitory computer readable storage medium such as a CD-ROM, a floppy disk, a hard drive, a DVD, a Blu-ray disk, or a memory associated with the processor 512, but the entire program and/or parts thereof could alternatively be executed by a device other than the processor 512 and/or embodied in firmware or dedicated hardware. Further, although the example program is described with reference to the flowchart illustrated in FIG. 3, many other methods of implementing the example audience measurement analyzer 200 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

As mentioned above, the example processes of FIG. 3 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

The program of FIG. 3 begins at block 302 where the example misattribution matrix generator 204 (FIG. 2) generates a misattribution matrix M across multiple demographic characteristics based on panelist data. At block 304, the example audience measurement data collector 202 (FIG. 2) obtains a misattributed census distribution F for the demographic characteristics from a database proprietor 106 (FIGS. 1A and 1B). At block 306, the example misattribution matrix generator 204 generates a column-conditioned misattribution matrix C by normalizing the misattribution matrix down the columns.

At block 308, the example census distribution analyzer 206 (FIG. 2) generates a vector corresponding to a census distribution model. In some examples, the elements in the vector corresponding to the census distribution model T are generated randomly. At block 310, the example census distribution analyzer 206 selects and/or assigns an a priori probability of selecting the census distribution model T to the model. In some examples, the vector and the associated probability is selected using the uniform Dirichlet distribution. At block 312, the example census distribution analyzer 206 calculates a misattribution probability vector P for the census distribution model T based on the column-conditioned misattribution matrix C. At block 314, the example census distribution analyzer 206 calculates the likelihood of the misattributed census distribution corresponds to the true census distribution G given the misattribution probability vector P for the census distribution model T. In some examples, this likelihood is calculated using the multinomial distribution (e.g., using Equation 9). At block 316, the example census distribution analyzer 206 calculates the posterior probability of the census distribution model T being true given the misattributed census distribution F. In some examples, this probability is calculated using Bayes' theorem (e.g., using Equation 15).

At block 318, the example census distribution analyzer 206 determines whether to analyze another census distribution model. If so, control returns to block 308. In some examples, the number of census distribution models is configured by a user interfacing with the audience measurement analyzer 200. In some examples, the number of census distribution models T to analyze is stored in a configuration file in a memory or storage space of a processor system (e.g., the database 210 of FIG. 2). The number of census distribution models T analyzed may be a relatively large number (e.g., 500, 000, 750, 000, 1,000,000, etc.) to cover a large number of possible solutions for the true census distribution G. If no additional census distribution models T are to be analyzed (block 318), control advances to block 320 where the example census distribution analyzer 206 calculates weighted averages of probabilities for each demographic characteristic across all of the census distribution models T. At block 322, the example census distribution analyzer 206 estimates the true census distribution G. In some examples, the true census distribution G is calculated by multiplying the total number of impressions across all demographic characteristics reported in the misattributed census distribution F by the sum of the weighted averages of the probabilities for each demographic characteristic. At block 324, the example report generator 208 (FIG. 2) generates a report based on the true census distribution. Thereafter, the example process of FIG. 3 ends. The report may be used by advertisers to assess the reach of an advertising campaign and the demographic composition of audience members of media associated with the advertising campaign.

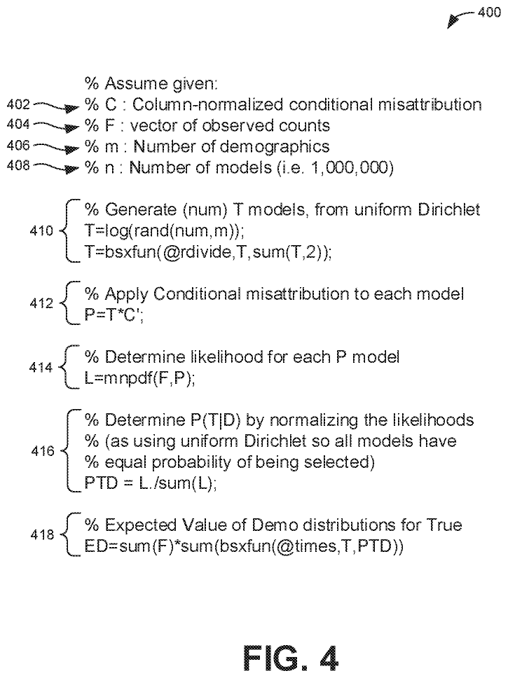

FIG. 4 is example computer code 400 that may be executed to implement the example audience measurement analyzer 200 of FIGS. 1A, 1B, and/or 2. The example code of FIG. 4 implements the same process outlined above in FIG. 3. Thus, as shown in the illustrated example of FIG. 4, parameters that are either directly obtained from other sources and/or calculated based on directly obtained data include the column-conditioned misattribution matrix C (identified by reference numeral 402), the misattributed census distribution F (identified by reference numeral 404), the number of demographic characteristics m (identified by reference numeral 406), and the number of census distribution models n (identified by reference numeral 408) to analyze (in this example, 1,000,000).

With the above parameters established, the example code 400 begins (at reference numeral 410) by generating the census distribution models T that are to be analyzed. As indicated in the illustrated example, the models are generated from the uniform Dirichlet distribution. Thereafter, at reference numeral 412, the column-conditioned misattribution matrix C is applied to the census distribution models T to generate the corresponding misattribution probability vectors P. At reference numeral 414, the likelihood of each census distribution model being true, given the misattributed census distribution F, is calculated using the multinomial distribution function (e.g., Equation 9). At block 416, the posterior probability of each model T, given the observed data (e.g., the misattributed census distribution F), is calculated. Finally, at reference numeral 418, the expected values for the true distribution are calculated from which the final true census distribution G may be calculated.

FIG. 5 is a block diagram of an example processor platform 500 structured to execute the instructions of FIGS. 3 and/or 4 to implement the audience measurement analyzer 200 of FIGS. 1A, 1B, and/or 2. The processor platform 500 can be, for example, a server, a personal computer, a workstation, a self-learning machine (e.g., a neural network), or any other type of computing device.

The processor platform 500 of the illustrated example includes a processor 512. The processor 512 of the illustrated example is hardware. For example, the processor 512 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example audience measurement data collector 202, the example misattribution matrix generator 204, the example census distribution analyzer 206, and the example report generator 208.

The processor 512 of the illustrated example includes a local memory 513 (e.g., a cache). The processor 512 of the illustrated example is in communication with a main memory including a volatile memory 514 and a non-volatile memory 516 via a bus 518. The volatile memory 514 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 516 may be implemented by flash memory and/or any other desired type of memory device. Access to the main memory 514, 516 is controlled by a memory controller.

The processor platform 500 of the illustrated example also includes an interface circuit 520. The interface circuit 520 may be implemented by any type of interface standard, such as an Ethernet interface, a universal serial bus (USB), a Bluetooth® interface, a near field communication (NFC) interface, and/or a PCI express interface.

In the illustrated example, one or more input devices 522 are connected to the interface circuit 520. The input device(s) 522 permit(s) a user to enter data and/or commands into the processor 512. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 524 are also connected to the interface circuit 520 of the illustrated example. The output devices 524 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 520 of the illustrated example, thus, typically includes a graphics driver card, a graphics driver chip and/or a graphics driver processor.

The interface circuit 520 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 526. The communication can be via, for example, an Ethernet connection, a digital subscriber line (DSL) connection, a telephone line connection, a coaxial cable system, a satellite system, a line-of-site wireless system, a cellular telephone system, etc.

The processor platform 500 of the illustrated example also includes one or more mass storage devices 528 for storing software and/or data. Examples of such mass storage devices 528 include floppy disk drives, hard drive disks, compact disk drives, Blu-ray disk drives, redundant array of independent disks (RAID) systems, and digital versatile disk (DVD) drives. In this example, the processor implements the example database 210

The machine executable instructions 532 of FIGS. 3 and/or 4 may be stored in the mass storage device 528, in the volatile memory 514, in the non-volatile memory 516, and/or on a removable non-transitory computer readable storage medium such as a CD or DVD.

From the foregoing, it will be appreciated that example methods, apparatus and articles of manufacture have been disclosed that correct misattribution in audience measurement census data obtained from database proprietors. The misattribution results from the limitations of the technological mechanisms used by database proprietors to generate the census data. In particular, database proprietors associate particular media impressions with particular individuals having known demographic characteristics based on cookie information and/or other user identifying information associated with the client device that is used to access the media. Because multiple different individuals may use the same client device, the database proprietor cannot reliably identify the actual person using the device based merely on identifying information tied to the client device. As a result of this situation, many media impressions tracked by database proprietors are misattributed to the wrong individual and, thus, credited to the wrong demographics when aggregated for provision to an AME. This technological problem is overcome by implementing teachings disclosed herein that rely on panelist data to calculate a misattribution matrix that can then be analyzed in connection with the observed data provided by the database proprietor using Bayes' theorem to estimate the true distribution of impressions for the census data. Further, examples disclosed herein overcome the methodologically flawed approaches used in the past by avoiding untrue assumptions to arrive at more reliable estimates of the true census distribution in a computationally efficient manner.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. An apparatus comprising:
a misattribution matrix generator to generate a misattribution matrix based on panelist data corresponding to audience measurement panelists, the misattribution matrix representing a panelist media impression as misattributed to a first demographic group by a database proprietor when the panelist media impression corresponds to a second demographic group; and
a census distribution analyzer to:
determine, based on the misattribution matrix, probability values that different census distribution models correspond to a true census distribution for census media impressions indicated in a misattributed census distribution obtained from the database proprietor, the true census distribution indicating a distribution of the census media impressions across the first and second demographic groups and accounting for misattribution by the database proprietor in the misattributed census distribution, the probability values determined based on the misattribution matrix; and
estimate the true census distribution based on the probability values.

2. The apparatus as defined in claim 1, wherein the census distribution analyzer is to randomly select values for the different census distribution models from a uniform Dirichlet distribution.

3. The apparatus as defined in claim 1, wherein the misattribution matrix generator is to generate a column-conditioned misattribution matrix by normalizing the misattribution matrix down columns, and the census distribution analyzer is to determine the probability values based on the column-conditioned misattribution matrix.

4. The apparatus as defined in claim 3, wherein the census distribution analyzer is to:
calculate misattribution probability vectors for the census distribution models based on the column-conditioned misattribution matrix; and
calculate the probability values using a multinomial distribution function with the misattribution probability vectors as inputs.

5. The apparatus as defined in claim 4, wherein the census distribution analyzer is to calculate posterior probabilities that respective ones of the census distribution models correspond to the true census distribution given the misattributed census distribution.

6. The apparatus as defined in claim 5, wherein the posterior probabilities are calculated using Bayes' theorem.

7. The apparatus as defined in claim 5, wherein the census distribution analyzer is to:
calculate weighted averages of the posterior probabilities across the census distribution models for the first and second demographic groups; and
estimate the true census distribution based on sums of the weighted averages of the posterior probabilities associated with the first and second demographic groups.

8. The apparatus as defined in claim 7, wherein the posterior probabilities are weighted based on the probability values for the corresponding census distribution models.

9. A non-transitory computer readable medium comprising instructions that, when executed, causes a machine to at least:
generate a misattribution matrix based on panelist data corresponding to audience measurement panelists, the misattribution matrix representing a panelist media impression as misattributed to a first demographic group by a database proprietor when the panelist media impression corresponds to a second demographic group;
determine, based on the misattribution matrix, probability values that different census distribution models correspond to a true census distribution for census media impressions indicated in a misattributed census distribution obtained from the database proprietor, the true census distribution indicating a distribution of the census media impressions across the first and second demographic groups and accounting for misattribution by the database proprietor in the misattributed census distribution; and
estimate the true census distribution based on the probability values.

10. The non-transitory computer readable medium as defined in claim 9, wherein the instructions further cause the machine to:
generate a column-conditioned misattribution matrix by normalizing the misattribution matrix down columns; and
determine the probability values based on the column-conditioned misattribution matrix.

11. The non-transitory computer readable medium as defined in claim 10, wherein the instructions further cause the machine to:
calculate misattribution probability vectors for the census distribution models based on the column-conditioned misattribution matrix; and
calculate the probability values using a multinomial distribution function with the misattribution probability vectors as inputs.

12. The non-transitory computer readable medium as defined in claim 11, wherein the instructions further cause the machine to calculate posterior probabilities that respective ones of the census distribution models correspond to the true census distribution given the misattributed census distribution.

13. The non-transitory computer readable medium as defined in claim 12, wherein the instructions further cause the machine to:
calculate weighted averages of the posterior probabilities across the census distribution models for the first and second demographic groups; and
estimate the true census distribution based on sums of the weighted averages of the posterior probabilities associated with the first and second demographic groups.

14. The non-transitory computer readable medium as defined in claim 13, wherein the posterior probabilities are weighted based on the probability values for the corresponding census distribution models.

15. A method comprising:
generating a misattribution matrix based on panelist data corresponding to audience measurement panelists, the misattribution matrix representing a panelist media impression as misattributed to a first demographic group by a database proprietor when the panelist media impression corresponds to a second demographic group;
determining, based on the misattribution matrix, probability values that different census distribution models correspond to a true census distribution for census media impressions indicated in a misattributed census distribution obtained from the database proprietor, the true census distribution indicating a distribution of the census media impressions across the first and second demographic groups and accounting for misattribution by the database proprietor in the misattributed census distribution; and
estimating the true census distribution based on the probability values.

16. The method as defined in claim 15, further including:
generating a column-conditioned misattribution matrix by normalizing the misattribution matrix down columns; and
determining the probability values based on the column-conditioned misattribution matrix.

17. The method as defined in claim 16, further including:
calculating misattribution probability vectors for the census distribution models based on the column-conditioned misattribution matrix; and
calculating the probability values using a multinomial distribution function with the misattribution probability vectors as inputs.

18. The method as defined in claim 17, further including calculating posterior probabilities that respective ones of the census distribution models correspond to the true census distribution given the misattributed census distribution.

19. The method as defined in claim 18, further including:
calculating weighted averages of the posterior probabilities across the census distribution models for the first and second demographic groups; and
estimating the true census distribution based on sums of the weighted averages of the posterior probabilities associated with the first and second demographic groups.

20. The method as defined in claim 19, wherein the posterior probabilities are weighted based on the probability values for the corresponding census distribution models.
